(19) United States
(12) Patent Application Publication
(10) Pub. No.: US 2025/0163277 A1
(43) Pub. Date: May 22, 2025

(54) BIOINSPIRED COATINGS, MATERIALS, AND STRUCTURES FOR THERMAL MANAGEMENT

(71) Applicant: THE REGENTS OF THE UNIVERSITY OF CALIFORNIA, Oakland, CA (US)

(72) Inventors: David Kisailus, Irvine, CA (US); Devis Montroni, Irvine, CA (US)

(21) Appl. No.: 18/841,593

(22) PCT Filed: Mar. 6, 2023
(86) PCT No.: PCT/US2023/014622

§ 371 Date: Aug. 26, 2024

Related U.S. Application Data
(60) Provisional application No. 63/316,745, filed on Mar. 4, 2022.

(51) Int. Cl. C09D 5/18; C09D 7/63; C09D 129/04; C09D 179/08; C09K 5/16

(52) U.S. Cl. CPC C09D 5/18; C09D 7/63; C09D 129/04; C09D 179/08; C09K 5/16

(57) ABSTRACT

Systems. materials. and methods for heat management and protecting a manufactured article or surface from thermal damage. The protective materials have heat absorbing elements comprised of a metastable or a thermally stable material. The materials include particles with high thermal conductivity. thermally conductive protrusions or patterns. heat absorbing matrices or layers, or a combination thereof. The materials can be applied to an article to prevent or reduce thermal damage.

### CROSS-REFERENCE TO RELATED APPLICATIONS

This application claims benefit of U.S. Provisional Application No. 63/316,745 filed Mar. 4, 2022, the specification(s) of which is/are incorporated herein in their entirety by reference.

### FIELD OF THE INVENTION

The present invention relates to materials, architectures, coating or structures for thermal management based on structural or compositional features derived from the thermal resistant seed coating in the plants from the Banksia genus.

### BACKGROUND OF THE INVENTION

The Banksia genus contains plants which after pollination develop a wooden structure, called follicle, that encase the seeds. These plants are typical of Western Australia or other areas where wildfire is natural events occurring every year. The constant exposure of some of these plants to periodic wildfire generated an evolutionary pressure that led to species dependent on the wildfire itself. Some species of Banksia, such as Banksia speciosa, are in fact dependent on wildfire to properly open the follicle structure, exposing the seed to the outside world to propagate during the first rain as shown in FIG. 5. This approach has few advantages for the seeds, such as lower competitions for growing or a more fertile substrate to grow on. On the other hand, the plant was forced to develop a thermal resistant system (composed of the follicle and all the structures inside of it, including the seed itself) that allows it to protect the seed from thermal and fire damages before and after the follicle opens (during the fire). The structural and compositional features in these plants of the Banksia genus were studied to develop new materials or structures for thermal/fire management and/or protection, or thermal activated materials.

### BRIEF SUMMARY OF THE INVENTION

It is an objective of the present invention to provide systems, materials, compositions and methods that provide thermal protection and allow for heat management, as specified in the independent claims. Embodiments of the invention are given in the dependent claims. Embodiments of the present invention can be freely combined with each other if they are not mutually exclusive.

Banksia speciosa is a plant relying on wildfires to propagate its seeds. Once the flower is pollinated, the plant develops a structure called follicle which encases two seeds. This structure, as much as the seed itself, have specific compositional and structural features that allow the seed to be protected from temperatures over a 1,000° C. Analogue systems from other species in the Banksia genus that do not rely on wildfires for propagation completely decompose and compromise the seeds if exposed to analogue thermal conditions. This system represents an intriguing source of knowledge for bioinspired systems for thermal management.

In some aspects, the present invention features novel methods for thermal management bioinspired from the coating on the seed. This coating shows specific compositional, morphological, and architectural features to create a last line of defense against thermal propagation. Generally, the system relies on a calcium oxalate crystal as heat catching unit and then dissipates/contains the heat into an organic matrix mostly composed of cellulose and lignin. This system is used to conceptualize different compositional and architectural features for thermal management. A few examples of designs based on these features are coatings for thermal protection, thermal resistant materials, materials able to manage thermal propagation such as by controlling directionality and speed of propagation, architectural features to control thermal convection, etc. As an additional value, the natural system relies on cheap and green materials, showing possible future developments of more ecological materials for thermal management.

In some embodiments, the present invention features a protective material for heat management and protecting a substrate from thermal damage. The protective material can comprise heat absorbing elements disposed on the substrate. In other embodiments, the protective material can further comprise a heat absorbing matrix disposed in the substrate. The heat absorbing matrix has heat dissipating pathways and insulating spacers, such as gaps, pockets, or bubbles, between said pathways. The heat absorbing elements are dispersed on, or at least a portion thereof is embedded within, the heat absorbing matrix.

In some embodiments, the pathways are connected to the substrate. In other embodiments, the pathways have minimal surface contact with the substrate. In other embodiments, the protective material can further comprise a separator that physically separates the heat absorbing elements from the heat absorbing matrix.

In one embodiment, the heat absorbing elements are particles, such as calcium oxalate crystals. In another embodiment, the heat absorbing elements are protrusions projecting from the substrate.

In some embodiments, the protective material can further comprise a heat sink layer. The heat absorbing elements can be fluidly coupled to the heat sink layer such that the energy from the heat absorbing elements is absorbed by the heat sink layer.

According to another embodiment, the protective material may comprise a heat absorbing matrix having heat dissipating pathways and insulating spacers between said pathways. Heat absorbing elements may be dispersed on, or at least a portion thereof is embedded within, the heat absorbing matrix. In other embodiments, the protective material further comprises a heat sink layer. The heat absorbing elements may be fluidly coupled to the heat sink layer.

According to another embodiment, the protective material may comprise a heat absorbing layer dispersed on the substrate, and thermally conductive protrusions that are dispersed on or in contact with the heat absorbing layer. The substrate may be dispersed on the heat absorbing layer and the thermally conductive protrusions are dispersed through the substrate and contacting the heat absorbing layer. These portions of the thermally conductive protrusions that are dispersed through the substrate can be coated with an insulating material that prevents heat from dissipating from said portions directly to the substrate. Heat can be absorbed by the thermally conductive protrusions and propagated to the heat absorbing layer. In some other embodiments, portions of the thermally conductive protrusions that are disposed through the substrate are coated with one or more insulating materials that prevent heat from dissipating from said portions directly to the substrate.

Without wishing to limit the invention to a particular theory or mechanism, the heat absorbing elements are configured to undergo degradation, dehydration or other physical or chemical processes to dissipate heat. The heat absorbing elements undergo thermal degradation or oxidation to produce a cooler layer and/or inert gas on a surface of the elements. In some embodiments, the heat absorbing elements are configured to propagate heat in a direction away from the substrate. For example, the heat absorbing elements are configured to propagate heat perpendicular to a surface of the substrate.

In other embodiments, the heat absorbing elements and the heat absorbing matrix are arranged concentrically to form cylindrical structures that propagate heat in a specific direction or to a specific area. In some other embodiments, the heat absorbing elements are arranged in a pattern on a surface of the substrate to prevent air convection or facilitate it in a specific direction.

According to another embodiment of the present invention, the protective material for heat management and protecting a substrate from thermal damage may comprise a heat absorbing matrix having heat dissipating pathways and insulating spacers between said pathways. In some embodiments, the protective material may further comprise heat absorbing elements disposed on or at least a portion thereof is embedded within the heat absorbing matrix.

In some embodiments, the protective material may be a coating disposed on at least a portion of the substrate. For example, the coating is disposed on a surface of the substrate.

In other aspects, the present invention features a method of preventing or reducing thermal damage to a substrate. The method may comprise applying the protective material described herein on at least a portion of the substrate. For example, the protective material may be applied to an exposed surface of the substrate.

One of the unique and inventive technical features of the present invention is the protective material comprising particles, an insulating matrix, or both. Without wishing to limit the invention to any theory or mechanism, it is believed that the technical features of the present invention advantageously absorb and dissipate heat. The protective material described herein can prevent thermal damage to the substrate when the substrate is exposed to temperatures up to 2000° C.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1 shows a non-limiting example of a thermal protective coating of the present invention having a foam layer with holes or pockets. The arrows indicate the phonon pathway in the material.

FIG. 2 shows a non-limiting example of a particle structure having anisotropic thermal conductivity. The arrows indicate the orientation of higher thermal conductivity in the material.

FIG. 3 shows another non-limiting example of a thermal protective coating of the present invention having a fiber layer.

FIG. 4 is another non-limiting example of a thermal protecting system of the present invention. The arrows indicate the phonon pathway in the material.

FIG. 5 shows a schematic of a Banksia follicle before and after being exposed to a wildfire.

FIG. 6A shows an SEM image of the seed coating showing the three main components: (1) the organic coated calcium oxalate crystal; (2) the root-like structures; (3) the organic network.

FIG. 6B is a low magnification SEM image of the coating and the relative Ca EDS-SEM map indicating the location of the crystals.

FIG. 6C is a broken seed coating section showing how the root-like structures are mostly thick and perpendicular close to the crystal and thin and more parallel to the seed surface getting closer to it.

FIG. 6D is an SEM image of a transversal section of the seed coating showing the whole system.

FIG. 6E is an SEM image of the layered structure of the thick root-like structure and the thin ones.

FIG. 6F is an SEM image of a transversal section of the coating showing the concentric organization of the root-like structures.

FIG. 6G is an SEM image of the layered structure of the thin root-like structure.

FIG. 6H shows a longitudinal section of the seed coating showing the layered organic coating on the crystal.

FIG. 7A shows a schematic of the crystal and root-like structure highlighting the possible influence on thermal protection. The longer arrow indicates the direct heat exchange between the crystal and the seed, and the shorter arrows indicate the lengthened pathway the heat is forced to take.

FIG. 7B shows the difference in the contact area between the crystal and the seed with (dots) and without (rectangle) the root-like structures.

FIG. 8A shows a longitudinal section of the coating showing how the crystal sits above the level of the organic network (arrows).

FIG. 8B is a section of the organic network showing its layered structure.

FIG. 9A shows a single calcium oxalate crystal showing the two subunits.

FIG. 9B shows an EDTA etched crystal showing the internal needle subunits.

FIG. 9C shows a broken crystal showing preferential planes of cleavage which resemble the internal needle organization.

FIG. 9D shows TGA (top) and DSC (bottom) profiles of the seed coating in air. Calcium oxalate signals are marked with a red dot.

FIG. 9E shows TGA (top) and DSC (bottom) profiles of a dehydrated calcium oxalate standard in air. Calcium oxalate signals are marked with a red dot.

FIG. 9F shows TGA (top) and DSC (bottom) profiles of a dehydrated calcium oxalate standard in Ar. Calcium oxalate signals are marked with a red dot.

FIG. 10A is a picture of a section of the entire follicle showing the two seeds and the spikes on the surface.

FIG. 10B is an SEM image of the seed surface showing many spikes.

FIG. 10C is an SEM image of a single spike showing some crystals along its base.

### DETAILED DESCRIPTION OF THE INVENTION

According to some preferred embodiments, the present invention provides anisotropic, crystallographically controlled materials for thermal control (“guiding heat”). Thermal conductivity can be controlled via tuning the crystallographic orientation of the material to synthesize anisotropic inorganic materials with controlled crystallographic ordering.

As used herein, the term “metastable” as known to one of ordinary skill in the art refers to an intermediate state in which a system can remain somewhat stable for a long period of time. In a non-limiting embodiment, when referring to thermodynamics, metastable can mean having the ability to absorb energy during heating. A material can be thermally stable to a specific temperature and then become unstable above it.

As used herein, the term “anisotropic” as known to one of ordinary skill in the art refers to a quality of exhibiting properties with different values when measured along axes in different directions. For instance, non-cubic symmetry crystals (e.g., wurtzite ZnO, quartz, graphite) can possess significant differences in thermal conductivity depending on their crystallographic orientation. For example, single crystal quartz has twice the thermal conductivity when parallel to the c-axis versus that perpendicular to the c-axis. In another example, graphitic materials exhibit more extreme differences in thermal conductivity, up to 200× more along the c-axis versus perpendicular to those planes.

Referring to FIG. 2, in some embodiments, the present invention features a layered insulating matrix. In one aspect, the layers may present a mismatch in thermal conductivity so that heat propagation is favored inside the same layer rather than through it. This mismatch may be due to composition, fibril alignment, or crystal orientation. In other embodiments, the layers may be arranged horizontally, concentric (i.e., creating cylindrical structures), or in patterns to manage the preferential direction of heat propagation. For example, the concentric cylindrical structures can act as “insulated” heat conducting wires to propagate heat in a specific direction or to a specific area (heat dumping).

According to some embodiments, the present invention uses geometrical features distributed on a surface to prevent air convection or facilitate it in a specific direction. For example, the features can create specific flows, such as laminar air flow. This feature may be applied from the macroscale (i.e., building distribution in a city) to the nanoscale (i.e., surface patterning).

According to other embodiments, a separator may be used to divide the underneath material from the heat catching element. Without wishing to limit the present invention, the separator can create a physical distance between two heat catching elements, act as an insulating layer (i.e., a foam), decrease and outdistance the points of contact (direct or indirect) between the two heat catching elements, create a longer pathway for the heat to follow, and combine multiple points of contact.

The heat absorbing features described herein, e.g., particles, spikes, matrix, patterns, and separators, may be used by itself or in combination with other features in the same system. In some preferred embodiments, the features could be used to protect from thermal damage or for thermal management (i.e., to collimate the heat in a single location where it could be stocked or dissipated).

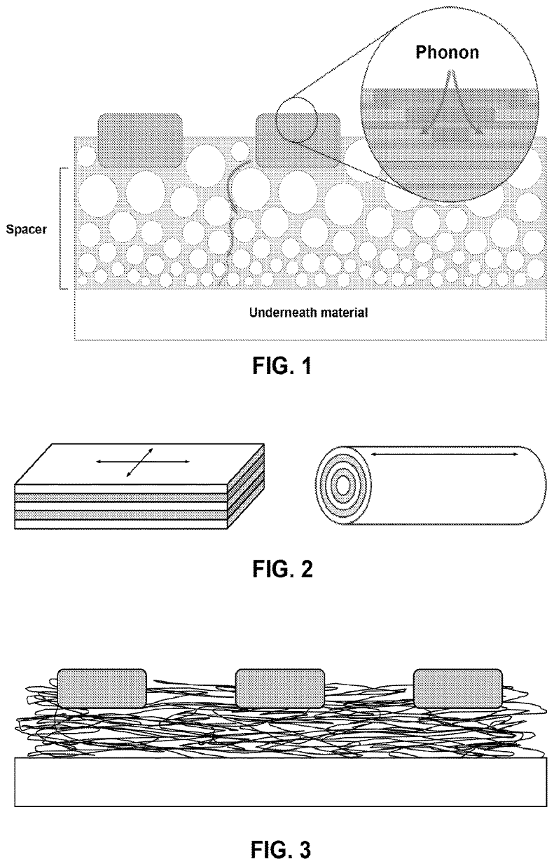

Referring now to FIGS. 1-3, the present invention features a protective material for heat management and protecting a substrate from thermal damage. In some embodiments, the protective material may comprise heat absorbing elements disposed on the substrate. In some embodiments, the protective material may further comprise a heat absorbing matrix disposed in the substrate. The heat absorbing matrix may comprise heat dissipating pathways and insulating spacers between said pathways. The heat absorbing elements can be dispersed on the heat absorbing matrix or at least a portion thereof is embedded within the heat absorbing matrix.

In some embodiments, the insulating spacers are gaps, pockets, or bubbles. The insulating spacers can vary in size. For example, the insulating spacers are larger closer to the heat absorbing elements and smaller closer to the substrate. In other embodiments, the pathways may be narrower in size closer to the substrate and thicker closer to the heat absorbing elements. In some embodiments, the pathways are connected or touching the substrate. In preferred embodiments, the pathways have minimal surface contact with the substrate. In other embodiments, the pathways closest to the surface of the substrate run parallel to said surface.

In some embodiments, the protective material further comprises a separator that physically separates the heat absorbing elements from the heat absorbing matrix. In other embodiments, the protective material has multiple separators that separate a heat absorbing element from its neighboring heat absorbing elements.

In one embodiment, the heat absorbing elements are particles. The particles can range in size from nanoparticles to microparticles. For example, a width or diameter of the particles can range from 10 nm to 500 μm. The particles can be spherical, cuboidal, prism, or other polyhedron shape.

In some embodiments, the particles can be crystals. In one embodiment, the crystals may be composed of any metastable material. As used herein, a metastable material is a material that can undergo a phase transformation at or slightly below a temperature in a range where heat may damage underlying structures. In another embodiment, the crystals may be composed of any thermally stable material. As used herein, a thermally stable material refers to a material that has an architecture buried within them that scatters or absorbs phonons. This kind of architecture may be a polycrystalline or mesocrystalline material. As a non-limiting example, the crystals may comprise calcium oxalate. In some embodiments, the polycrystalline materials may have a different component or an amorphous phase intercalated among the crystal domains.

According to some embodiments, the protective material for heat management and protecting an article from thermal damage may comprise heat absorbing elements that are comprised of a metastable or a thermally stable material. In some embodiments, the heat absorbing elements have anisotropic thermal conductivity. In some embodiments, the heat absorbing elements can direct heat in a desired path. For instance, the heat absorbing elements absorb heat and guide it in a direction away from the article. In some embodiments, the heat absorbing elements direct heat along a specific path that is longer or more difficult as compared to a traditional conductive path. In other embodiments, the heat absorbing elements have isotropic thermal conductivity.

In some embodiments, the material may further comprise a heat absorbing matrix having heat dissipating pathways and insulating spacers between said pathways. The heat absorbing elements may be disposed on the heat absorbing matrix, or at least a portion thereof is embedded within the heat absorbing matrix. The heat absorbing matrix is configured to separate the heat absorbing elements from each other. For example, the heat absorbing matrix separates the heat absorbing elements from the article such that the heat absorbing elements are further away from the article. The heat absorbing matrix is configured to absorb heat. Without wishing to limit the present invention to a particular theory or mechanism, the heat dissipating pathways and insulating spacers can reduce the heat absorbed by the article. Non-limiting examples of the heat absorbing matrix include foam, a foam ceramic matrix, glass fibers with minimal contact, natural or synthetic fibers, lignin or derivatives thereof, a synthetic lignin derivative, a methacrylate, or a biopolymer derivative. It is understood that these aforementioned materials are intended to be examples only, and are non-limiting and non-exhaustive. Other compounds and materials are within the scope of the present invention.

According to some embodiments, the heat absorbing elements are configured to undergo degradation, dehydration or other physical or chemical processes to dissipate heat. In some embodiments, the heat absorbing elements can undergo thermal degradation or oxidation to produce a cooler layer and/or inert gas on a surface of the elements. In some embodiments, the heat absorbing elements are configured to be applied onto the article such that they propagate heat in a direction away from the article. The angle of propagation to delay phonon propagation to the inside of the article can range from about 0.1°-90° from the surface of the article. In other embodiments, the heat absorbing elements are configured to propagate heat parallel to or perpendicular to a surface of the article, or any angle in between.

Examples of the configuration of the heat absorbing elements include, but are not limited to, particles, needles, wires, filaments, or thin films. In some embodiments, the heat absorbing elements are crystalline or amorphous. In other embodiments, the heat absorbing elements are comprised of a polycrystalline or mesocrystalline material, or a polycrystalline material having a different component or an amorphous phase intercalated among its crystal domains.

In some embodiments, the material of the heat absorbing elements may comprise a glass material, a ceramic material, ceramic-polymer composites, ceramic-ceramic composites, ceramic-metal composites, or polymer-polymer composites. In some embodiments, the material of the heat absorbing elements may include, but are not limited to, oxides, oxohydroxides, nitrides, oxynitrides, carbides, oxycarbides, carbonates, sulfates, oxalates, or phosphates. In other embodiments, the material of the heat absorbing elements may comprise calcium oxalate, aluminum oxide, magnesium carbonate, copper carbonate, gallium nitride, zinc oxide, zinc sulfide, or a zinc blend. These examples of the heat absorbing elements (calcium oxalate, aluminum oxide, etc) have metastable phases. For instance, zinc blend refers to a cubic metastable phase of wurtzite, which is the thermodynamically stable hexagonal phase. As another example, aluminum oxide has many metastable phases that are useful before they form alpha-aluminum oxide (beta, gamma, eta, etc.). It is understood that these aforementioned compounds are intended to be examples only, and are non-limiting and non-exhaustive. Other compounds and materials are within the scope of the present invention.

In some embodiments, the heat absorbing elements and the heat absorbing matrix may be arranged concentrically to form cylindrical structures that propagate heat in a specific direction or to a specific area. In some embodiments, the heat absorbing elements are arranged in a pattern on a surface of the article to prevent air convection or facilitate it in a specific direction.

In some embodiments, the material can be applied on at least a portion of the article. For example, the material is a protective coating disposed on at least a portion of the article or the article itself is constructed from said material.

Alternatively or in conjunction, the heat absorbing elements can be protrusions projecting from the article. The protective material may further comprise a heat sink layer, and the heat absorbing elements are thermally coupled to the heat sink layer.

According to another embodiment of the present invention, the protective material may comprise a heat absorbing matrix having heat dissipating pathways and insulating spacers between said pathways. The material can be a protective coating dispersed on at least a portion of the article or the article itself is constructed from said material. Heat absorbing elements may be optionally dispersed on or at least a portion thereof is embedded within the heat absorbing matrix.

According to another embodiment of the present invention, the protective material may comprise heat absorbing elements having anisotropic thermal conductivity.

The present invention may also feature manufactured articles comprising the protective material coating at least a portion of the article or the article may be constructed from the protective material. In another embodiment, the present invention may feature a manufactured surface comprising the protective material disposed on a surface or a surface constructed from the protective material. The protective material can be according to any of the embodiments described herein. In some embodiments, the manufactured article is a roofing material, a building material, furniture, a cooking tool, a construction tool, an appliance, an article of clothing, safety gear, personal protective gear, or an electronic device. In some embodiments, the article may be used for aerospace (e.g., space and/or aviation), automotive, or construction applications.

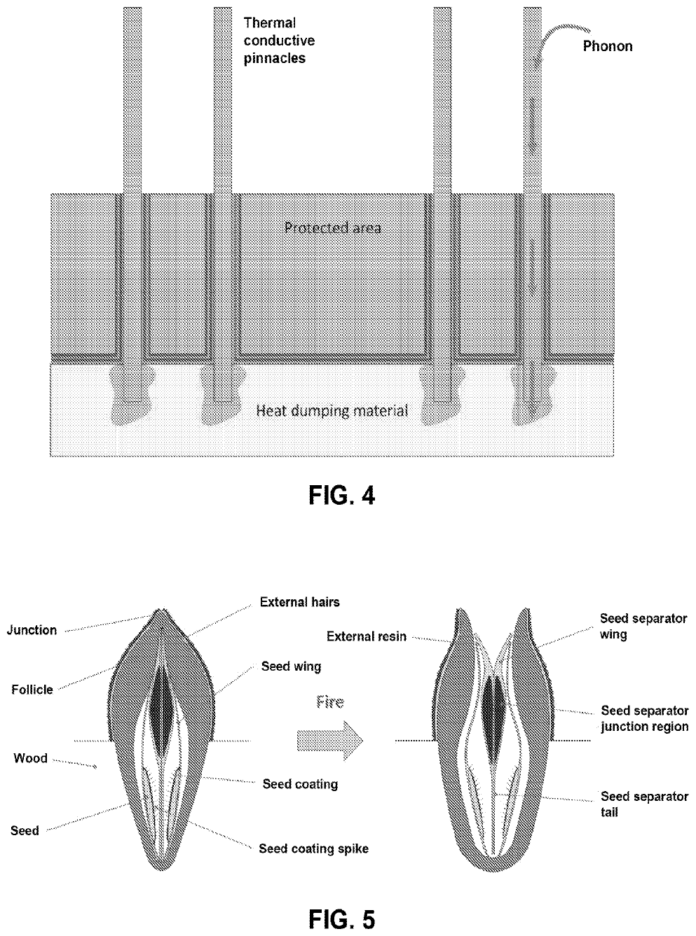

In another embodiment, as shown in FIG. 4, the protective material may comprise a heat absorbing layer disposed on the article, and thermally conductive protrusions that are dispersed on or in contact with the heat absorbing layer. The thermally conductive protrusions are dispersed through the article and contacting the heat absorbing layer such that heat is absorbed by the thermally conductive protrusions and propagated to the heat absorbing layer. In some embodiments, portions of the thermally conductive protrusions that are dispersed through the article may be coated with an insulating material that prevents heat from dissipating from said portions directly to the article. The protective material can be used to produce a manufactured article in which the heat absorbing layer is disposed on at least a portion of the article. The thermally conductive protrusions are disposed through the article and are in contact with the heat absorbing layer. In one embodiment, the thermally conductive protrusions are projecting from a surface of the article and the heat absorbing layer is disposed on an opposing surface of the article. In preferred embodiments, the article is a sensor, a computer chip, or an electronic component. In other embodiments, the article is a roofing material, a building material, furniture, a cooking tool, a construction tool, an appliance, an article of clothing, personal protective gear, or an electronic device. The manufactured article may be used in aerospace, automotive, or construction applications.

Since the materials have been described herein, it is thus another objective of the present invention to provide methods of utilizing these materials to prevent or reduce thermal damage to an article or surface. In some embodiments, the present invention provides a method of preventing or reducing thermal damage to an article, the method comprising applying a heat absorbing layer protective material on a surface of the article, and applying thermally conductive protrusions on an opposing surface of the article such that the thermally conductive protrusions are disposed through the article and are in contact with the heat absorbing layer.

In other embodiments, the method of preventing or reducing thermal damage to an article may comprise applying a heat absorbing matrix on at least a portion of the article, where the heat absorbing matrix comprises heat dissipating pathways and insulating spacers between said pathways, and applying heat absorbing elements on the heat absorbing matrix, where the heat absorbing elements are disposed on or at least a portion thereof is embedded within the heat absorbing matrix. The steps of applying the heat absorbing elements or applying the heat absorbing elements may be accomplished by 3D printing, dip coating, painting, spray coating, spin coating, layer adhesion, or drop casting.

In some other embodiments, the method may comprise applying a protective material on at least a portion of the article or constructing or forming the article with the protective material. In yet other embodiments, the method may comprise applying a protective material on at least a portion of the surface or constructing or forming the surface with the protective material. The protective material may be according to any of the materials described herein. In some embodiments, the protective material may be applied by 3D printing, painting, dip coating, spray coating, spin coating, layer adhesion, or drop casting. In other embodiments, constructing or forming the material may comprise 3D printing, molding, casting, extrusion, or additive manufacturing.

Without wishing to limit the present invention to a particular theory or mechanism, the protective material can prevent thermal damage to the article when the article is exposed to temperatures of about 500° C. or higher. In preferred embodiments, the protective material can prevent thermal damage to the article when the article is exposed to temperatures ranging from ambient temperature to about 2000° C.

Referring to FIG. 5, a dark layer on the most exposed face of the seed (the one pointing to the extern, once the follicle opens) was defined as seed coating. This coating represents the last line of defense from thermal damage of the seed. Despite not being in direct contact with the fire, the intern of the follicle is anyway exposed to temperatures of a couple hundred degrees Celsius once the follicle opens. In normal conditions, these temperatures would be enough to damage the embryo and devitalize permanently the seed. To avoid this, the seed evolved a coating that prevents this damage by slowing down the heat diffusion to the seed surface.

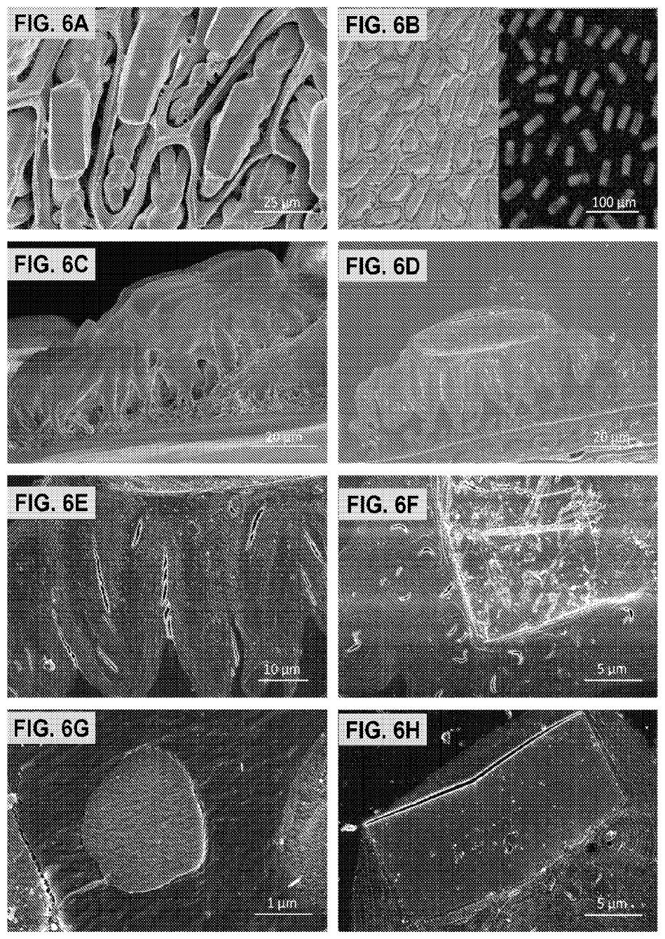

Referring to FIGS. 6A-6B, the seed coating presents three main morphological components: (i) a calcium oxalate crystal with an organic coating; (ii) root-like structures that connect the calcium oxalate crystal to the seed; and (iii) an organic network that separate the calcium oxalate crystals. The composition of the organic matrices is mostly lignin and cellulose I. As shown in FIG. 6A, a single calcium oxalate crystal, combined with the root-like structures, constitute a little island that is separated from other ones by the organic network. No interaction between the organic network and these island constituents has been observed at any depth of the structure.

Referring to FIGS. 6C-6D, it can be observed how the crystal is located on top of the structure and the root-like structure connects it to the surface of the seed. It is also visible that the root-like structures start as thick tubular structures in contact with the crystal and then branch into thinner roots once below the level of the crystal. Observing a broken section, it is visible how the roots form two organizations: one right below the crystal where the roots are still relatively thick and with a general perpendicular orientation in respect to the seed surface, and a second one closer to the seed surface where the roots are thin and with many branches organized parallel to the seed surface. Sections also highlighted how the thicker roots have an alternate concentric organization in cellulose-rich and lignin-rich layers as shown in FIGS. 6E-6F. This layer organization was also observed in the organic matrix covering the crystals, shown in FIG. 6H. No layers were observed in the thin roots layer shown in FIG. 6G.

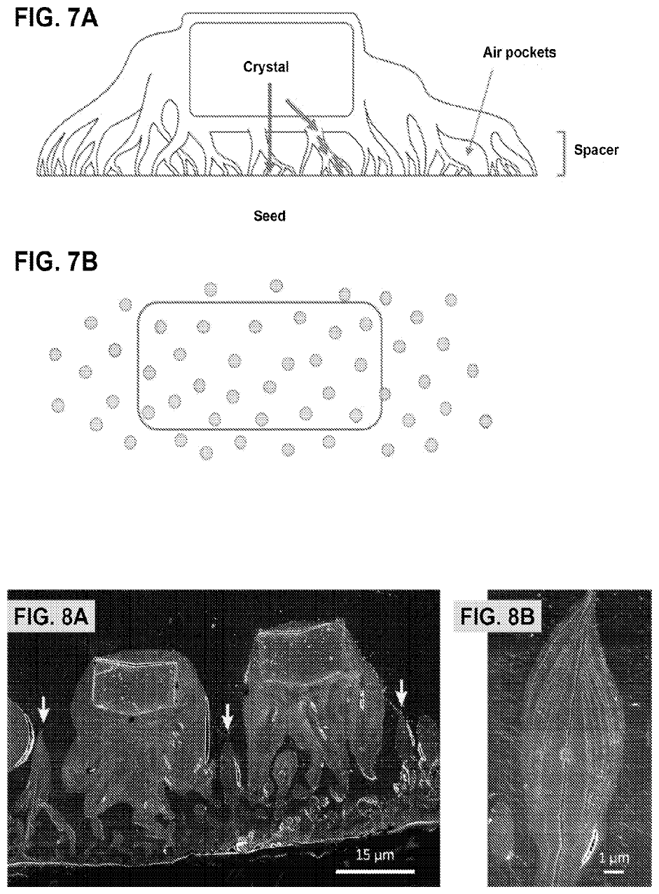

Without wishing to limit the present invention to a particular theory or mechanism, it is theorized that the calcium oxalate crystal is exposed and acts as a thermal antenna because it has a better thermal conductivity as compared to the organic matrix, collecting the heat that surrounds the seed. Once the crystal is heated, the heat is forced inside the organic matrix. Referring to FIGS. 7A-7B, the root-like structure is supposed to mostly play four roles: (i) creating a spacing between the crystal and the seed so that no the heat collected on the crystal cannot be passed to the seed; (ii) decrease and spread out the contact surface between the crystal and the seed surface; (iii) lengthen the path of heat conductivity between the crystal and the seed; and (iv) create air pockets that act as insulator. The concentric organization of the organic phase would create interfaces that impede heat transfer, thus increasing the insulating properties of the root. This would be functional considering the creation of insulating air pockets below the crystals and the propagation of heat from the crystal into the organic matrix that would be forced to use the longer pathway possible. Moreover, the absence of this concentric organization in the thin root would, instead, allow a better dissipation of the heat from the organic matrix to the surrounding air.

Referring to FIG. 8A, the organic network was observed being below the level of the crystal, separating the root-like structure or different islands. Its internal organization is made of layers, analogous to the root-like structures, and organized perpendicular to the seed surface as shown in FIG. 8B. A thin-root branching was observed on the network as well. Without wishing to limit the present invention to a particular theory or mechanism, the network likely evolved as an insulator that separates the different crystals to prevent lateral diffusion of heat. The thin-root, again, would prevent significant heat transfer between the organic network, which is exposed to the outer surface, and the seed surface.

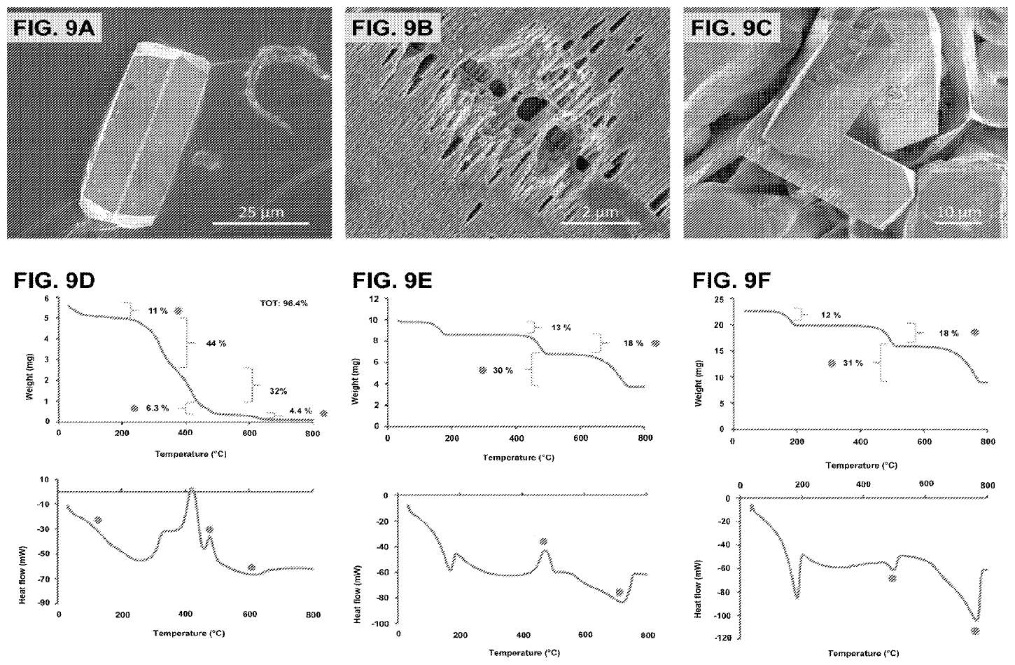

Referring to FIG. 9A, each crystal has a specific organization in that it is divided into two subunits. Despite the single crystal appearance of each subunit, etching and fracturing experiments showed an inner organization in needles perpendicular to the interface between the units as shown in FIGS. 9B-9C. The needles are aligned both along the main and the minor axis of the crystal. The needles do not seem to be separated by a pure organic matrix but a less crystalline interface with a different organic content might be present. The organization of the crystal too could be involved in thermal protection. A phonon would preferentially diffuse in the crystalline regions, meaning these less crystalline interfaces would impede phonon conductivity to allow the thermal energy to preferentially diffuse horizontally along the crystal, rather than perpendicularly to the seed surface.

Moreover, the crystals are actually dihydrated calcium oxalate. TGA/DSC analyses of a standard dihydrated calcium oxalate showed how the dehydration process (occurring between 100 and 200° C.) is an endothermic event, meaning the crystals absorb heat upon dehydration. This also represents an important adaptation in the thermal protection of the seed. Also, in case the temperature rises too much, calcium oxalate can convert into calcium carbonate (400-500° C.) and then calcium oxide (600-800° C.), both endothermic events in the absence of oxygen, which has been reasonably consumed by the fire. TGA and DSC profiles are reported in FIGS. 9D-9F.

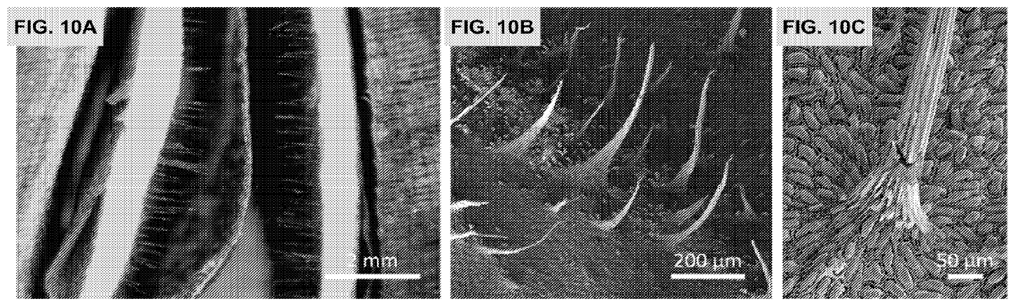

In some embodiments, the seed coating also presents another feature likely involved in thermal protection. Referring to FIG. 10A, the coating presents many spikes a few millimeters long. These spikes are composed of the same organic matrix of the coating and only few crystals are present on their external surface, mostly along the base. The crystals present on the spikes, in a region higher than the level of the base, lose their organic coating and the root-like structure. The spikes are mostly flat as shown in FIG. 10B, and does not seem to have a preferential orientation on the seed. However, they seem to avoid being perpendicular to the main axis of the seed. The spikes may have different roles: (i) being involved in the seed propagation, such as gripping to animals or other substrates; (ii) works as spacer between the seed and the seed separator avoiding eventual heat conduction between the structures; (iii) act as an antenna, collecting heat and chilling the environment or consuming oxygen while degrading; and (iv) impede air convection inside the follicle, decreasing heat distribution.

Without wishing to limit the invention to a particular theory or mechanism, the present invention features systems, materials, or coatings for thermal protection or heat management that emulate more precisely (biomimicry) or extract (bioinspired) some features of the seed coating. In some embodiments, the present invention utilizes particles (i.e., crystals, nanoparticles) with a higher thermal conductivity, as compared to the embedding matrix, as collector of heat to prevent its diffusion. As a non-limiting example, the nanostructured crystals can control (i.e., directionality, attenuation) the phonon diffusion inside the crystal itself.

In other embodiments, the particles may undergo degradation, dehydration or other physical or chemical processes that would dissipate the heat collected. In some embodiments, the materials can absorb heat while degrading. Some examples include materials that undergo hydration or chemical conversion (i.e., oxalates converting into carbonates). As another example, the present invention may utilize exposed features, such as the spikes, that can degrade due to heat or oxygen consumption. In some embodiments, the exposed features can undergo thermal degradation or oxidation to produce a cold layer and/or more inert gas on the material surface.

### EXAMPLES

The following are non-limiting examples of the present invention. It is to be understood that said examples are not intended to limit the present invention in any way. Equivalents or substitutes are within the scope of the present invention.

According to an exemplary embodiment, based on FIG. 1, a suspension of metastable and mesocrystalline particles (e.g., mesocrystalline calcium oxalate) dispersed in a solution of polyimide that has been mixed under an inert gas (e.g., N₂ or Argon) is prepared so that the suspension not only contains the particles, but gas bubbles that will yield a foam. Before application, the metastable particles should be synthesized using aqueous mixtures of calcium chloride and sodium oxalate at near neutral pH (e.g., 6.5) at room temperature, but combined with polyvinyl alcohol (PVA) where the concentration of PVA is sufficiently high to lead to a mesocrystalline particle state. This will enable many grain boundaries within the particles which will also deflect phonons. These suspensions will be coated on surfaces using either spray coating or even by brush coating to form the final product.

In another embodiment, as shown in FIG. 1, the present invention features a two layered coating with oriented crystal nanoparticles on top and a foam layer with a gradient in air bubble distribution beneath. The crystal nanoparticles are mesocrystals with more and less alternating crystalline layers aligned parallel to the coating surface, this would allow heat propagation preferentially horizontally in the crystal. The underneath layer is an insulating foam with bigger inert gas bubbles close to the crystal and more tinier gas bubbles close to the underneath surface. This geometry would act as an insulating spacer between the crystals and the underneath surface. The different bubble sizes would create an intricate pattern for heat conduction with more exposed surface localized far from the crystal where heat can be dissipated more easily.

Referring to FIG. 4, thermal conductive pinnacles can be patterned to protect exposed areas of a surface, for example acting as a sensor. The conductive pinnacles run through the material and are then connected to a storage underneath the surface where they are in contact with a material that degrades when heated. The portion of the pinnacles inside the material is covered with alternate layers with different fibril orientation of an insulating polymer. When the material surface is exposed to heat, the pinnacles heat up and the heat is propagated through the material, without inducing any damage to it, and collected in the storage reservoir, where it is automatically dissipated by thermal degradation.

As used herein, the term “about” refers to plus or minus 10% of the referenced number.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

1. A protective material for heat management and protecting an article from thermal damage, the protective material comprising heat absorbing elements, wherein the heat absorbing elements are comprised of a metastable or a thermally stable material.

2. The protective material of claim 1, further comprising a heat absorbing matrix having heat dissipating pathways and insulating spacers between said pathways, wherein the heat absorbing elements are disposed on or at least a portion thereof is embedded within the heat absorbing matrix, wherein the heat absorbing matrix is configured to separate the heat absorbing elements from each other.

3. (canceled)

4. The protective material of claim 2, wherein the insulating spacers vary in size.

5. The protective material of claim 4, wherein the insulating spacers are larger closer to the heat absorbing elements and smaller further away from the heat absorbing elements.

6. The protective material of claim 2, wherein the pathways are narrower in size further away from the heat absorbing elements and thicker closer to the heat absorbing elements.

7. The protective material of claim 2, further comprising a separator that physically separates the heat absorbing elements from the heat absorbing matrix.

8. The protective material of claim 2, wherein the material is adapted to be applied on at least a portion of the article, wherein the heat absorbing matrix separates the heat absorbing elements from the article such that the heat absorbing elements are further away from the article.

9. The protective material of claim 1, wherein the heat absorbing elements have anisotropic thermal conductivity.

10. The protective material of claim 9, wherein the heat absorbing elements direct heat along a specific path that is longer or more difficult as compared to a traditional conductive path.

11. The protective material of claim 9, wherein the heat absorbing elements direct heat in a desired path, wherein the heat absorbing elements absorbs heat and guides it in a direction away from the article.

12. The protective material of claim 1, wherein the heat absorbing elements have isotropic thermal conductivity.

13-15. (canceled)

16. The protective material of claim 1, wherein the heat absorbing elements are crystalline or amorphous.

17-19. (canceled)

20. The protective material of claim 1, wherein the heat absorbing elements are configured to undergo degradation, dehydration or other physical or chemical processes to dissipate heat.

21. (canceled).

22. The protective material of claim 1, wherein the heat absorbing elements are configured to be applied onto the article such that they propagate heat in a direction away from the article.

23-24. (Canceled)

25. The protective material of claim 2, wherein the heat absorbing elements and the heat absorbing matrix are arranged concentrically to form cylindrical structures that propagate heat in a specific direction or to a specific area.

26-27. (Canceled)

28. The protective material of claim 1, wherein the heat absorbing elements are protrusions projecting from the article.

29. The protective material of claim 1, further comprising a heat sink layer.

30. The protective material of claim 1, wherein the heat absorbing elements are thermally coupled to the heat sink layer.

31-37. (Canceled)

38. A protective material for heat management and protecting an article from thermal damage, the protective material comprising a heat absorbing layer disposed on the article, and thermally conductive protrusions that are dispersed on or in contact with the heat absorbing layer.

39-45. (canceled)

46. A method of preventing or reducing thermal damage to an article, the method comprising:
a. applying a heat absorbing layer protective material on a surface of the article; and
b. applying thermally conductive protrusions on an opposing surface of the article such that the thermally conductive protrusions are disposed through the article and are in contact with the heat absorbing layer.

47-54. (canceled)
